(19) United States
(12) Patent Application Publication
(10) Pub. No.: US 2024/0167714 A1
(43) Pub. Date: May 23, 2024

(54) HAZE-CONTROL SYSTEM

(71) Applicant: sndwrks LLC, Denver, CO (US)

(72) Inventors: John Daniel McKenna, Denver, CO (US); Daniel Bernard McKenna, Detroit Lakes, MN (US)

(21) Appl. No.: 18/514,558

(22) Filed: Nov. 20, 2023

Related U.S. Application Data
(60) Provisional application No. 63/426,510, filed on Nov. 18, 2022.

(51) Int. Cl. F24F 11/63

(52) U.S. Cl. CPC F24F 11/63

(57) ABSTRACT

Various examples described herein include various mechanisms, techniques, and methods to control atmospheric effects in a venue. For example, a method for controlling atmospheric effects in a venue is disclosed. The method includes querying and receiving a number of particulate sensors; analyzing particulate sensor-data received from the plurality of particulate sensors; making a determination whether the particulate sensor-data substantially agrees with a pre-determined target level of an environmental effect; and based on a determination that the particulate sensor-data does not agree substantially with the pre-determined target level of the environmental effect, sending a command signal to one or more haze generators to vary a haze production level; and based on a determination that the particulate sensor-data does agree substantially with the pre-determined target level of the environmental effect, making a determination whether additional haze sequences remain to be completed within the venue. Other systems, techniques, and methods are also disclosed.

### CLAIM OF PRIORITY

This application claims the priority benefit to U.S. Provisional Patent Application Ser. No. 63/426,510, filed on 18 Nov. 2022, and entitled “HAZE-CONTROL SYSTEM,” which is incorporated by reference herein in its entirety.

### TECHNOLOGY FIELD

The disclosed subject matter is related generally to the field of generating and controlling special effects within, for example, various venues if the entertainment industry. More specifically, in various embodiments, the disclosed subject matter is related to various types of creating and controlling special effects (such as a generation and control of haze) in various performance venues within the entertainment industry.

### BACKGROUND

Current methods of adding haze (e.g., smoke-like effects) to a theater, concert venue, sound stage, movie set, television set, and so on (e.g., a venue in general) is typically achieved with using aerosolized polyethylene glycol (PEG), to create a non-transparent vapor. The aerosolized PEG reflects at least portions of the visible light spectrum, therefore changing the optical light transmission through the haze volume. A lighting designer for a venue can use this effect to enhance, for example, the feeling and emotive content (e.g., a “look”) of a given performance.

However, there is currently no method to measure a level of haze being produced, nor is there a way to actively induce feedback to either increase or reduce haze in a substantially real-time manner. Further, heating, ventilation, and air-conditioning (HVAC) systems in buildings can dramatically impact the generation or persistence of haze, by either removing the haze too quickly, or by leaving the haze present too long. The impact of HVAC systems on haze is at least partially dependent on HVAC settings and a general arrangement (e.g., locations and volumetric flow rates of various supply and return lines) of the HVAC system within a building. In addition, there is a growing concern that repeated exposure by, for example, actors or musicians, to continuous levels of generated haze may be harmful to tissues within human lungs.

As described in more detail below, it would be ideal to integrate haze control with haze particle-size measurements, as well as the quantity of haze, both in time and spatial volume, to ensure a desired level of haze particulates are being generated. In addition, one haze-control system type of architecture would be to integrate the haze platform with the lighting console for active feedback to manage haze start/stop as well as haze magnitude, and further integration with venue HVAC for managing how quickly or slowly the HVAC system removes the haze from the stage arena.

The disclosed subject matter presented herein provides a relatively fast and cost-effective system and method to generate and control special effects (e.g., atmospheric effects, such as haze) within a performance venue. However, the information described in this section is provided to offer a person of ordinary skill in the art a context for the following disclosed subject matter and should not be considered as admitted prior art.

### SUMMARY

This document describes, among other things, various types of techniques, methods, and mechanisms to control atmospheric effects of a live or recorded performance (e.g., a live theater event, a television event to be broadcast at a later time, a musical performance, etc.) The atmospheric effects can include controlling generated haze effects and fog effects. Various types of haze and fog are defined herein. However, a person of ordinary skill in the art, upon reading and understanding the disclosed subject matter, will soon recognize that the disclosed subject matter is readily adaptable to many types of situations, such as used in traffic control, construction locations, mining operations, and many other diverse environments.

In various embodiments described herein, a method for controlling atmospheric effects in a venue is disclosed. The method includes querying and receiving data from at least one sensor, such as a number of particulate sensors (e.g., in various embodiments, the sensors may be deployed multidimensionally); analyzing sensor-data, such as, for example, particulate data, received from the at least one sensor; making a determination whether the sensor-data substantially agrees with a pre-determined target level of an environmental effect; and based on a determination that the sensor-data does not agree substantially with the pre-determined target level of the environmental effect, sending a command signal to one or more haze generators to vary a haze production level; and based on a determination that the sensor-data does agree substantially with the pre-determined target level of the environmental effect, making a determination whether additional haze sequences remain to be completed within the venue.

In various embodiments described herein, a system to control atmospheric effects within a venue is disclosed. The system includes at least one sensor and a server to collect data from the at least one sensor. The server is further arranged to analyze the collected data and make a determination whether the sensor-data substantially agrees with a pre-determined target level of an environmental effect. The server is further arranged to control one or more haze generators based on the determination that the sensor-data does not substantially agree with the pre-determined target level of the environmental effect. The system further includes at least one dashboard to view at least analyzed versions of the collected data and to control the server. A database is coupled to the server. The database includes a lookup table of a number of pre-determined target levels of environmental effects of the venue (e.g., that may vary temporally or by a given location or venue).

In various embodiments described herein, a tangible, computer-readable medium to perform operations is disclosed. When the operations are executed by one or more hardware-based computers of a machine, the machine is arranged to perform operations including querying and receiving data from at least one sensor; analyzing sensor-data received from the at least one sensor; making a determination whether the sensor-data substantially agrees with a pre-determined target level of an environmental effect; and based on a determination that the sensor-data does not agree substantially with the pre-determined target level of the environmental effect, sending a command signal to one or more haze generators to vary a haze production level; and based on a determination that the sensor-data does agree substantially with the pre-determined target level of the environmental effect, making a determination whether additional haze sequences remain to be completed within the venue.

In various embodiments, the disclosed haze-control detection and generation process can be fully automated. In other embodiments, the disclosed haze-control detection and generation process can have at least certain aspects that may be controlled manually. For example, during a live, outdoor venue, a stage manager or other end-user of the system can, semi-permanently or temporarily, reprogram the system to compensate for a sudden wind change or a somewhat persistent and directional wind effect (e.g., “focused” wind effects due to an arrangement of the audience seating).

Further, as described in more detail below, multiple haze systems could be deployed spatially on a stage, or proximate to the stage, to enable multidimensional haze-effects. Consequently, multidimensional haze-effects can be shaped to have various haze volumes to be within one or more desired envelopes.

In various embodiments, the system has an ability to use previously-collected data, from a variety of venues and program types, to use the data in a machine-learning (ML) capacity based on, for example, visual data (e.g., collected by still and/or video cameras), particulate-sensor data, wind velocity data (e.g., collected from one or more anemometers distributed across the stage and/or in the general environment, especially in outdoor venues), and other parameters as disclosed herein. The ML data can allow the system to make anticipatory and predictive changes in various parameters to control environmental effects based on a current performance in combination with collected data from previous performances. These embodiments are discussed in more detail herein.

### BRIEF DESCRIPTION OF FIGURES

Various ones of the appended drawings merely illustrate example implementations of the present disclosure and should not be considered as limiting a scope of the disclosure.

FIG. 1 shows an example of a high-level overview of a haze-control system, in accordance with various embodiments described herein;

FIG. 2 shows an example of a high-level overview of an expanded version of the haze-control system of FIG. 1, in accordance with various embodiments described herein;

FIGS. 3A and 3B show a generalized example of a method for using the haze-control system of, for example, FIG. 1 or FIG. 2, in accordance with various embodiments of the disclosed subject matter described herein;

FIGS. 4A and 4B show a specific exemplary embodiment of a block diagram of an example haze-control system, in accordance with various embodiments described herein; and

FIG. 5 shows a block diagram of an example comprising a machine upon which any one or more of the techniques (e.g., methodologies) discussed herein may be performed.

### DETAILED DESCRIPTION

The disclosed subject matter is directed to systems and method to control atmospheric effects of a live or recorded performance (e.g., a live theater event, a television event to be broadcast at a later time, a musical performance, etc.). The atmospheric effects can include controlling generated haze effects and fog effects. In the entertainment industry, fog is considered to be an atmospheric effect that is low-lying and generally denser than air (i.e., fog is not dispersed into the air). Haze is considered an atmospheric effect that is dispersed in the air substantially evenly. Haze can also be spatially non-uniform in its extent such as, for example, a more complex scenic-lighting effect. Although various types of venues in which the performances may occur are used in the entertainment industry, the disclosed subject matter can also be adapted readily to environments that include, but are not limited to, ventilation of automobile tunnels, ventilation in mining operations, ventilation of various types of factories, ventilation from and within refineries and chemical plants, and ventilation of smoke from buildings and other locations. Therefore, the concepts of fog and haze as discussed herein are provided merely as examples to more fully illustrate various concepts.

For example, “atmospherics” may be used in military applications for various reasons. During training, haze can be used to simulate battle conditions more realistically. The disclosed subject matter can maintain these conditions to create a predicable environment for training. Additionally, atmospherics are used tactically in warfare to change a battlefield environment. For example, a commander may deploy a line of lower-lying atmospherics to screen friendly movements from an enemy observer. The disclosed subject matter allows for empirical measurements of the battlefield conditions allowing commanders full control over maneuvers. Such battlefield conditions may then be saved and later replicated in subsequent training missions.

In addition to generating and controlling atmospheric effects of a live or recorded performance, various aspects of the disclosed subject matter can also be used to monitor and record aspects of the generated atmospheric effects (e.g., haze particulates or particles) within the venue that are potentially deleterious to human safety. For example, it is well known that particle inhalation of particular types, kinds (e.g., materials), and concentration levels has a potential to damage human lung tissue and transfer chemicals into the blood stream, There is research showing negative effects on people exposed to haze. Therefore, the various embodiments of the haze-control systems disclosed herein can also be used to monitor generated haze levels to comply with current and future industry and governmental regulations and guidelines. Additionally, with regard to the entertainment industry, there are also guidelines related to, for example, various types of actors' unions, which may have guidelines related to haze exposure and other requirements.

For example, particles with an aerodynamic diameter of approximately 0.5 to 5 μm have the highest probability of depositing into a human lung, with the smaller particles having a greater probability to penetrate deeply into the lung. Particles with aerodynamic particles much larger than 5 μm tend to impact in the oropharyngeal cavity.

Human lungs have an internal surface area of between about 75 and about 140 square meters (e.g., approximately equivalent to the surface area of a tennis court). In one study, the mean alveolar number for a number of tested adults was estimated to be about 480 million, with a range of 274 million to 790 million. The alveolar number was closely related to total lung volume, with larger lungs having considerably more alveoli. Since the human lungs have direct contact with the outside environment, the lungs provide a primary gateway for the entry of microparticles and nanoparticles, such as haze particles, into the body.

The disclosed subject matter is configured to monitor substantially constant as well as multidimensional particulate levels (both particle-size ranges and particle concentration levels) over time (e.g., as a function of time) to indicate to a system operator when exposure levels have reached potentially harmful levels (e.g., of a performer working within the environments described herein).

Embodiments of the disclosed subject matter, including the haze-control systems and related methods, described herein allows creation and management of the particulate generation and maintenance. For example, in various embodiments, the haze-control system can ramp-up haze, reduce a generated level of haze, change the type of haze produced, maintain a level of haze in spite of various external factors (e.g., local building HVAC systems and related components, including external weather effects) as well as other variables as described in more detail below.

Consequently, various embodiments of the haze-control system provide multidimensional atmospheric-effects, in a changing time domain, for numerous types of entertainment and performance venues. The entertainment and performance venues include, for example, theaters, concert halls, movie complexes, wedding ceremonies, corporate-marketing productions, and other types of venues known in the art. The haze-control system uses, for example, a combination of electronic hardware, local and wide area computer networking (which could be wired or wireless in their extent), advanced computer-processors with graphic engines, artificial intelligence and machine learning for automated predictive-algorithm learning and control methods, direct operating controls via a lighting console, and local and/or remote control interfaces via one or more remote computer-based dashboards. A composite systems-level result of the disclosed subject matter is a haze platform that delivers an exceptionally accurate and repeatable multidimensional level of haze experience over time to the audience and entertainment industry, regardless of venue, either in an indoor environment or an outdoor environment.

In various embodiments, the disclosed subject matter provides a solution to the various haze production and maintenance problems by incorporating one or more precision aerosol particle counters (e.g., a particulate sensor) with control software. Multiple distributed ones of the particle counters are located spatially in the venue (e.g., a theater or concert stage) to count aerosolized particles (in various forms as defined in more detail, below) from one or more haze generators in a substantially real-time manner. These distributed sensor assemblies can be coupled via communications networks (e.g., ethernet or WiFi) to a central computer processor that aggregates the data and analyzes the composite haze environment for a current snapshot in time (e.g., a selected time element) in the theater or concert venue. The lighting designer, or others associated with the venue, such as a lighting-system operator, can then make decisions on how the haze-control system is performing based on the graphed and real-time data the designer is observing. The designer and/or other operator can then manually adjust the haze-control system up or down as desired to create the visual effect the lighting designer, director, or producer is seeking.

As described in more detail below, in automated as well as artificial intelligence (AI)-based haze-control systems, the algorithms automatically adjust the haze based on collected measured haze data versus a lighting operator manually adjusting the haze system. The machine learning algorithms can take visual data and learn the pattern desired for a consistent level of haze based on multiple data points (e.g., from cameras, particle measurements, ambient conditions, HVAC, etc.) and extrapolate that information into control algorithms and logic that adjusts the levels of haze in the theater. Analyzing these data over a given timeframe, the server controlling the haze-control system progressively becomes better, more accurate, and more efficient at controlling the haze levels, thereby leading to a much more accurate presentation to any given audience, regardless of venue.

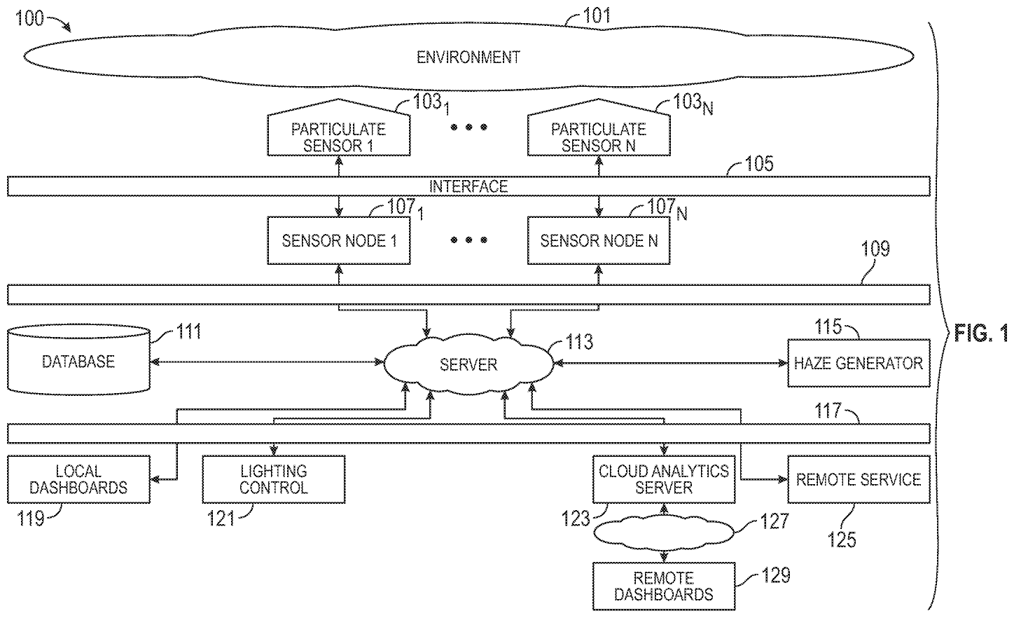

FIG. 1 shows a high-level overview of a haze-control system 100, in accordance with various embodiments described herein. Therefore, FIG. 1 is provided merely as one type of haze-control system and should not be considered as limiting the disclosed subject matter in any way. Moreover, all or portions of the haze-control system 100 of FIG. 1 may be replicated to enhance a level of particle detection, haze generation, local and remote dashboards to control the system, and so on, as described in more detail herein.

Moreover, upon reading and understanding the disclosed subject matter, a person of ordinary skill in the art will recognize that not all of the elements shown in FIG. 1 may be used in all venues, and that many or all elements and components may be replicated many times depending upon, for example, a level of control desired (e.g., complex generations of haze in multiple portions of a given scene) or the amount of haze that is generated for a given scene (e.g., thereby possibly using multiple haze generators). Consequently, the skilled artisan will recognize that FIG. 1 provides an overview of just one example of a haze-control system. The skilled artisan will further recognize that not all elements need to be coupled (e.g., electronically) to other elements as shown. The elements may be coupled to one another in other ways. Therefore, the skilled artisan will recognize that FIG. 1 provides an overview of a haze-control system that may be arranged differently or customized for a given use and purpose. However, the various arrangements are considered as being within a scope of the given disclosure.

The high-level overview of the haze-control system 100 is shown to include an environment 101 in which the haze-control system 100 is configured to operate, a number of particulate sensors 103₁ to 103_{N}, an interface 105 coupled between the particulate sensors 103₁ to 103_{N} and a respective number of sensor nodes 107₁ to 107_{N}, and a network-coupling element 109 to couple data electronically to and from the particulate sensors and the sensor nodes to a server 113. The data may be coupled between the various components, for example, wirelessly, hard-wired, optically, or by other communications means known in the relevant communications art. Further, various forms of data communications are envisioned and multiple forms of communications may be used.

The server 113 is, in turn, coupled to a database 111 and one or more haze generators 115, as well as through a second network-coupling element 117. The second network-coupling element 117 is configured to couple electronically signals traveling to and from the server 113 to one or more local dashboards 119, a lighting-control module 121, a cloud-based analytics server 123, and a remote-service module 125. The cloud-based analytics server 123 may communicate electronically with one or more remote dashboards 129 through a communications network 127. Each of the aforementioned elements and components is described in more detail below.

With continuing reference to the haze-control system 100 of FIG. 1, the environment 101 considers a venue in which a performance (e.g., live theater, other stage productions, concerts, etc.) is to be held. Factors within the environment 101 that can be controlled or considered include ambient particle levels in the air (including particle size or sizes, particle size distributions, particle shapes, and other particle characteristics including particle material composition, density, etc.), temperatures, humidity levels, and other factors. These factors can be changed by multiple sources including, for example, haze generators, HVAC systems, a total number of audience members present at a given venue, lighting fixtures, as well as a number of other sources. As noted above, there are multiple types of atmospheric effects that could exist such as haze (particles spread substantially evenly throughout a given, selected spatial volume), fog (low-lying particles), or dust particles.

The particulate sensors 103; to 103_{N} can include various types of airborne particle-sensors that can measure and report measurements such as a particle-size range (e.g., to consider particulate matter that can be inhaled into the lungs) and particle concentration (e.g., a count per unit volume such as particles per cubic meter of particles per cubic foot). Additionally, the particulate sensors can categorize the particle measurement by size and/or concentration of the particle in different geographical locations within the environment 101. This categorization allows references of multiple measurement points to maintain accuracy of atmospheric conditions (e.g., generated-haze levels) from performance-to-performance (e.g., show-to-show) as well as venue-to-venue (e.g., from one production facility to another). For example, a live production may seek to emote a substantially consistent visual effect in each performance that is also venue independent. As described in more detail below, the haze-control system 100 is able to integrate, spatially, readings of the haze level from the particulate sensors 103₁ to 103_{N} to determine a spatial distribution of the haze. Further, the haze-control system 100 is able to determine a temporal distribution of the haze across a defined spatial extent. Readings from each of the particulate sensors 103₁ to 103_{N} may then be compared with a pre-determined level of haze correlated with, for example, a given scene of the performance within a given venue.

Although only two particulate sensors are shown, upon reading and understanding the disclosed subject matter, the skilled artisan will recognize that any number of particulate sensors may be used depending on factors such as an overall volume within the environment 101 that is to be controlled, and individual volumes within the overall volume that are to be controlled (e.g., a difference in particle concentration levels of different portions of a stage, different particle concentration levels during different temporal periods during a venue, etc.). The particulate sensors 103₁ to 103_{N} can include, for example, optical particle-counters (OPCs), condensation particle-counters (CPCs), and other particulate sensors known in the relevant art.

Each of the particulate sensors 103₁ to 103_{N} is communicatively coupled to a sensor node 107₁ to 107_{N} through the interface 105. The interface 105 may comprise both wired and wireless communications types. For example, wired communication types may include one or more types of serial interfaces, parallel interfaces, or other hard-wired interfaces known in the art. Wireless communication types may place the particulate sensors 103₁ to 103_{N} in communication with various ones of the sensor nodes 107₁ to 107_{N} via communication standards as found in wireless data networks (e.g., the Institute of Electrical and Electronics Engineers (IEEE) 802.22 family of standards known as Wi-Fi®, the IEEE 802.26 family of standards known as WiMax®), Bluetooth®, and other wireless standards known in the art. Each of the interface types may support bi-lateral communications between the particulate sensors 103₁ to 103_{N} and one or more sensor nodes 107₁ to 107_{N}. Although FIG. 1 is shown to include the same number of sensor nodes 107; to 107_{N} as particulate sensors 103₁ to 103_{N}, no such implication is necessarily intended. For example, a plurality of particulate sensors may be configured to communicate with a single sensor node.

In a specific exemplary embodiment, the sensor nodes 107₁ to 107_{N} consist of a serial interface to one or more hardware-based microcomputers (not shown explicitly but understandable to a person of ordinary skill in the art) to translate sensor data and transmit these data to the server 113. Microprocessors may be incorporated into one or more of the sensor nodes. In this example, the microcomputer can automatically synchronize with the server 113 on power up and begin to transmit measurement data from the particulate sensors 103₁ to 103_{N} upon initialization of the various components of hardware (e.g., the particulate sensors and the one or more microcomputers). In addition to the measurement data, the sensor nodes 107₁ to 107_{N} can also transmit health telemetry of various ones of the hardware components such as a capacity and usage level of each computer-processing unit (CPU), memory usage, disk usage, voltage levels, power usage, sensor states, network states, video, temperature, humidity, wind speed and direction, and other parameters for operation of the haze-control system 100.

The database 111 may comprise at least one of a local database and a remote database (coupled, for example, wirelessly for electronic communications with the haze-control system 100 as described in more detail below). The database can comprise one or more of a time-series type of database, a relational database, a document-store database, and other database types. The database 111 is configured to capture and retain sensor measurements (persistent and temporal), system and hardware configurations and setups, system analytics, and other types of data. Each of these databases can be aggregated and synchronized with a cloud-based server when an Internet connection is available. The databases may persist information indefinitely or for a certain pre-determined period of time. Further, although only a single database is shown, any number of databased may be incorporated into the haze-control system 100.

In various embodiments, the server 113 can be located within a given venue and/or remotely (e.g., through multiple instantiations of the server 113). The server 113 can be responsible for overall system operations, which includes querying sensors via coupled sensor nodes, managing data acquisition and storage, processing the sensor data, communicating with lighting console equipment and computers, and various other tasks used in the operation of the haze-control system 100. The server 113 can function as a message broker to transmit messages from the server 113 to various endpoints within the system and store messages received from other components within the system as they are received. The server 113 can manage system configurations through persisted configuration data (e.g., received from the database 111). The server 113 may also be configured to run via a microprocessor contained within the server 113, for example, a web server to distribute website-based dashboards locally and remotely as described in more detail below. Further, the server 113 can also send substantially real-time system analytics to the cloud for primary or additional processing and storage.

The haze generator 115 is configured to create haze atmospheric-effects during a live performance. In various embodiments, the haze generator 115 uses aerosolized polyethylene glycol (PEG) to create a semi-transparent to non-transparent vapor that reflects light. The haze generator 115 can also use various types of other working fluids including polyols (such as organic compound containing multiple hydroxyl groups), mineral oils (such as mixtures of higher alkanes), and other glycols (such as butyl glycol, diethylene glycol, propylene glycol, dipropylene glycol, and triethylene glycol) to generate haze by atomization of the working fluid.

A lighting designer (or other operator) for a given performance (typically a live, real-time performance), can determine a haze level or levels that are appropriate at different times throughout the performance. Further, performances often have technical rehearsals (e.g., typically without audiences) that may not be considered actual performances. However, as used herein, a performance may include an actual performance, a technical rehearsal, or various variations as would be understood to a person of ordinary skill in the art. Additionally, the performance could also be a recorded performance for playback at a later time or date, such as a movie or a performance intended for streaming. The levels of haze selected by the lighting designer are measured by the particulate sensors 103₁ to 103_{N} and may be recorded and stored to, for example, the database 111 to provide haze levels for comparison with similar performances in the same or different venues at a later time period. The haze generator 115 can be controlled either manually or via programming from the haze-control system 100 as described in more detail below, to create a multidimensional haze-effect at a given point during the performance. Additionally, particulate sizes, shapes, material types, and quantities (e.g., particle densities) can also be controlled by the haze-control system 100, to enhance further an ability of the lighting designer to create an emotive effect during a scene in the performance.

The one or more local dashboards 119 can be arranged to operate like a local intranet, and display various metrics and data from the haze-control system 100 via, for example, numerical, graphical, and/or visual representations. Additionally, the one or more local dashboards 119 allow for local configuration of the haze-control system 100, and further allow for a remote reset and shutdown of the system without having to access physically, for example, the particulate sensors 103₁ to 103_{N}. A webpage, for example, provided by the server 113, and running on the one or more local dashboards 119 also has options to alert the viewer when parameters are in or out of a pre-defined range, as described in more detail herein. Consequently, there are various viewer-accessible configuration parameters.

The haze-control system 100 can receive operating state updates from the lighting-control module 121 to include, for example, which devices are currently available and the status of those devices. The haze-control system 100 can send messages to the lighting-control module 121 such as to turn a specific device on or off or adjust levels or operations of specific devices. Additionally, the lighting-control module 121 can override control of atmospheric devices. Such override control can be advantageous in cases of a malfunction or an emergency. Consequently, personnel such as a lighting operator, a theater operator, and/or a stage manager can take control of various ones of the atmospheric systems. The haze-control system 100 can therefore send and receive control data pursuant to atmospheric operations.

The cloud-based analytics server 123 is configured to perform operations such as receiving, processing, and storing data from the haze-control system 100 and feed configurations back to the system in case of, for example, system failure (backup systems are described in more detail, below). The architecture of using the cloud-based analytics server 123 coupled to the haze-control system 100 allows for data backup, retrieval, and diagnostics either locally (with reference to the venue) or remotely. Further, despite the name “cloud-based,” in various embodiments, the cloud-based analytics server 123 may be located locally, exclusively, and/or replicated both locally and remotely.

The communications network 127 may be a local Intranet (e.g., a local-area network (LAN) or a wide-area network (WAN)) or may be based on Internet-based communications. In various embodiments, the communications network 127 may be similar to or the same as the interface 105, the network-coupling element 109, and/or the second network-coupling element 117. Additionally, the interface 105, the network-coupling element 109, and/or the second network-coupling element 117 may all be considered to be a common component with reference to each other and/or the communications network 127.

The one or more remote dashboards 129 allow for remote monitoring and configuration of various components of the haze-control system 100. In various embodiments, the one or more remote dashboards 129 can be deployed in various geographical locations to allow operation of the haze-control system 100 by users (e.g., pre-defined users allowed to operate the system) and other stakeholders not within the environment 101. For example, this arrangement of dashboards could be used for a remote operation of system diagnostics and troubleshooting purposes through, for example, the remote-service module 125. Further, each of the one or more remote dashboards 129 may be distributed geographically with reference to other ones of the remote dashboards 129. Each of the remote dashboards 129 can include a login portal for a multi-user, multi-tenant experience. Multiple users can log into view system data, thereby allowing for monitoring of a given performance without being in the same building as the performance.

The remote-service module 125 provides a connection with the haze-control system 100 for development and troubleshooting. The connection may be achieved by, for example, a reverse secure-socket shell (SSH) tunnel, a virtual private-network (VPN), screen-share remote software, and other methods known in the relevant art. Various types of communication security, quality-of-service (QOS), latency, and other factors may be considered as understandable to a person of ordinary skill in the art based upon reading and understanding the disclosed subject matter.

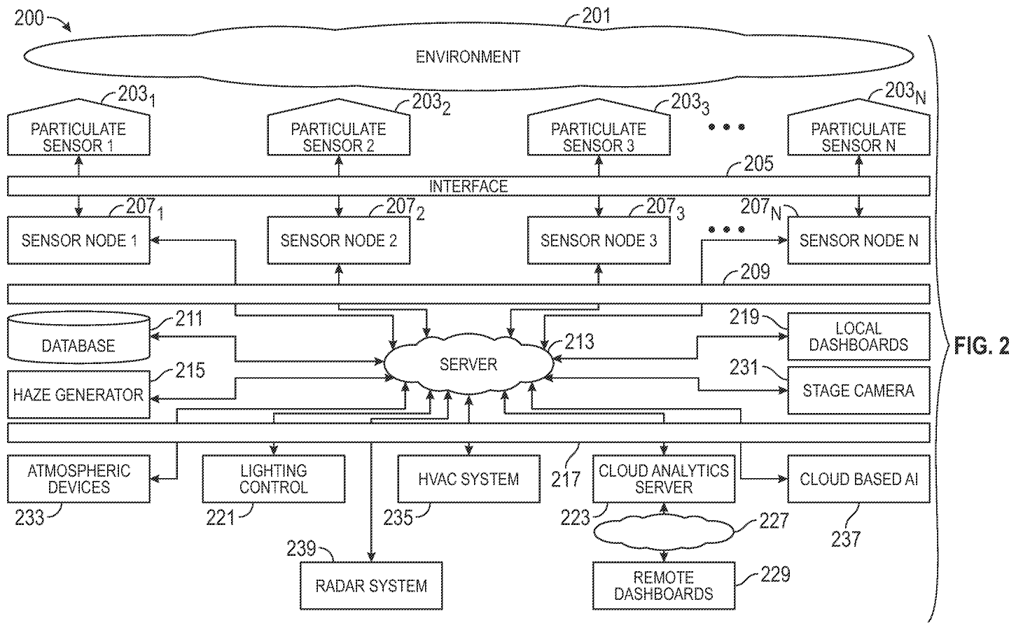

With reference now to FIG. 2, an example of a high-level overview of an expanded version of the haze-control system 100 of FIG. 1, in accordance with various embodiments described herein, is shown. Each of the components and elements of the expanded haze-control system 200 of FIG. 2 may be similar to or the same as related elements and components of the haze-control system 100 of FIG. 1. Therefore, FIG. 2 is provided merely as another type of haze-control system and should not be considered as limiting the disclosed subject matter in any way.

Moreover, all or portions of the haze-control system 200 of FIG. 2 may be replicated to enhance a level of particle detection, haze generation, local and remote dashboards to control the system, and so on. Additionally, upon reading and understanding the disclosed subject matter, a person of ordinary skill in the art will recognize that not all of the elements shown in FIG. 2 may be used in all venues, and that many elements and components may be replicated many times depending upon, for example, a level of control desired (e.g., complex generations of haze in multiple portions of a given scene) or the amount of haze that is generated for a given scene (e.g., thereby using multiple haze generators).

Consequently, the skilled artisan will recognize that FIG. 2 provides an overview of another example of a haze-control system. The skilled artisan will further recognize that not all elements need to be coupled (e.g., electronically) to other elements as shown. The elements may be coupled to one another in other ways. Therefore, the skilled artisan will recognize that the haze-control system 200 of FIG. 2 provides an overview of a haze-control system that may be arranged differently or customized for a given use and purpose. However, the various arrangements are considered as being within a scope of this disclosure. Overall, the haze-control system 200 can scale to as many nodes as is desired.

In some ways similar the control system of FIG. 1, the high-level overview of the haze-control system 200 is shown to include an environment 201 in which the haze-control system 200 is configured to operate, a number of particulate sensors 203₁, 203₂, 203₃, to 203_{N} (203₁ to 203_{N}), an interface 205 coupled between the particulate sensors 203₁ to 203_{N}, a respective number of sensor nodes 207₁, 207₂, 207₃, to 207_{N} (207₁ to 207_{N}), and a network-coupling element 209 to couple data electronically to and from the particulate sensors and the sensor nodes to a server 213. Although the particulate sensors 203₁ to 203_{N} are shown in a one-to-one correspondence with the sensor nodes 207₁ to 207_{N}, no such limitation is intended. Therefore the “pairing” of the sensors and nodes of haze-control system 200 is provided merely as one example.

The server 213 is, in turn, coupled to a database 211 and one or more haze generators 215, as well as through a second network-coupling element 217. The server may include one or more microprocessors to analyze and control aspects of the haze-control system 200 as described in more detail, below. The second network-coupling element 217 is configured to couple electronically signals traveling to and from the server 213 to one or more local dashboards 219, one or more stage cameras 231, a lighting-control module 221 (e.g., a lighting console or general control console), a radar system 239 (e.g., containing millimeter-wave communications as well as supplemental detection systems to sense, for example, an extent, shape, and depth of a spatial and temporal particle distribution and concentration), a cloud-based analytics server 223, one or more HVAC systems 235 (e.g., already existing within the venue housing the performance), a cloud-based artificial-intelligence (AI) module 237 (e.g., to assist in controlling the haze-control system 200), and an atmospheric-devices control-module 233 (e.g., atmospheric-devices can include other types of special-effects generators associated with a performance such as pyrotechnic-based displays or other types of effects).

The cloud-based analytics server 223 may communicate electronically with one or more remote dashboards 229 through a communications network 227. As with FIG. 1, each of the elements and components may be distributed geographically or contained within the environment 201 in which the performance is to occur. Further, each of the elements and components may be distributed spatially, physically, or logically within the environment 201 in which the performance is to occur. Additionally, the cloud-based analytics server 223 can receive, process, and store data from the haze-control system 200 and feed configurations back to the system in case of a system failure. The architecture of using the cloud-based analytics server 123 coupled to the haze-control system 100 allows for data backup, retrieval, and diagnostics either locally (with reference to the venue) or remotely. Various ones of the servers, such as the server 213 or the cloud-based analytics server 223, can also execute and run data-processing algorithms to filter and aggregate data as it is received over a given timeframe. The servers can also store and serve data for the remote dashboards 229. Despite the name “cloud-based,” in various embodiments, the cloud-based analytics server 223, as well as the cloud-based AI module 237, may be located locally, exclusively, and/or replicated both locally and remotely.

The environment 201 of the venue may consist of parameters such as ambient-air particle levels, temperature, and humidity levels. These parameters can often be changed by multiple sources such as the haze generators 216, one or more HVAC systems 235, audience members (which can vary depending upon venue type and time-of-year, including heavier and more light- and particle-absorbent clothing in colder temperatures or seasons), lighting fixtures, and other physical and temporal elements which can affect the environment 201. As noted above with reference to FIG. 1, there are multiple types of atmospheric effects that could exist such as haze (particles spread substantially evenly throughout the volume or volumes that are monitored), fog (low-lying particles), or dust particles, and including variations of these types that are inter-mixed.

A total number of the particulate sensors 203₁ to 203_{N} can be dependent on factor such as the physical size and type of performance (e.g., a theatrical performance or a musical performance dependent), where the sensors are spatially located within the venue to determine a multidimensional effective-haze environment, and so on. The particulate sensors 203₁ to 203_{N} can categorize the particle measurement by a size of the particle as well as particle concentration in different geographical locations within the venue, thereby allowing a reference of multiple measurement points to maintain accuracy of atmospherics from performance-to-performance and venue-to-venue.

The one or more stage cameras 231 can comprise various types of still and motion cameras (e.g., including optical and/or digital cameras). In addition to, for example, a typical broadcast-style motion camera, the one or more stage cameras 231 can also include camera boards to facilitate at least one of a two-dimensional (2D) and a three-dimensional (3D) representation of the performance and a visual indication of the atmospheric conditions (e.g., providing a visual indication of haze levels during the performance). As will be recognizable to a person of ordinary skill in the art, upon reading and understanding the disclosed subject matter, the “visual indication” can also include indications that are outside a human visual range (e.g., wavelengths in the infrared range or other parts of a non-visible spectrum that are not visible to humans but discernible by, for example, cameras, including, for example, portions of the electromagnetic spectrum in a millimeter-wavelength range as discussed below). The one or more stage cameras 231 can also include an image sensor (e.g., a CCD array, a CMOS-based sensor, an active-pixel sensor, or other sensor types). In embodiments, the image sensor may also be coupled with an electronic and/or mechanical shutter. The one or more stage cameras 231 may also include an image-processing mode that is configurable for either 2D and/or 3D images. Therefore, the one or more stage cameras 231 may also provide an input to the cloud-based AI module 237 to interpret the haze atmospherics environment under a machine-learning model, described in more detail below. The one or more stage cameras 231 also allow for local and remote monitoring of the performance for consistency.

In various embodiments, the one or more stage cameras 231 may also include one or more camera lens that are controllable (e.g., for focus and zoom, as well as panning and tilting of the camera) by the haze-control system 200.

All controllable elements shown within FIG. 2 (e.g., the one or more haze generators 215, the one or more stage cameras 231, the one or more HVAC systems 235, other atmospheric devices, and so on) may be controlled directly or indirectly through the lighting-control module 221. Additionally, each component or element within the environment 201, including remote elements not directly within the environment 201, may report back to the server 213 when they are on, running, and/or in need of service or supplies. The components or elements can be on a local network. Alternatively, the lighting-control module 221 can be triggered via various messaging formats known in the communications art. Further, the lighting-control module 221 can also be used to override control of any of the atmospheric devices within the system. As noted, the system sends and receives control data pursuant to atmospheric operations. The override control can be used to ensure the atmospherics can be normalized in the event of, for example, a system malfunction.

As noted above, the one or more HVAC systems 235 can have a significant effect of parameters such as haze production, both spatially and temporally, during a performance. Consequently, the haze-control system 200 can monitor an activation of, for example, fans, blowers, air handlers, and temperature controllers (e.g., heating and air conditioning) within the one or more HVAC systems 235. Therefore, the haze-control system 200 can control various functions within the one or more HVAC systems 235 as needed to maintain and adjust a quality level of the haze atmospherics. This control functionality may be realized by another microcomputer or microprocessor (not shown) that can be used to tie into an HVAC system within a given venue. In one example, a lighting scenic-effect uses haze that persists in a longer-than-typical timeframe. In this example, the haze-control system 200 can transmit a control message to stage-area HVAC systems to reduce or stop HVAC operations for a given timeframe (e.g., for several minutes). Subsequently, an additional control message is transmitted to the stage-area HVAC systems to ramp up to clear generated haze quickly.

The cloud-based AI module 237 can pull data from various servers to analyze and predict decision making based on multiple factors for each haze-control system 200 for geographically distributed instantiations of the haze-control system 200 operating in different locations or venues, or on a unique per-system, per-venue basis. The AI algorithm can use the sensor data to run predictive analytics that show how to control atmospherics. The AI process includes learning when the various atmospheric devices are pre-determined to be triggered. The AI process monitors visual content from the system (still images, video content, etc.) in both spatial and temporal domains, to make decisions about the current look of the show relative to sensor measurements. Also, if requested, the AI process can make comparisons with, for example, previous performances of performances from other venues.

Further, as used herein, the AI algorithms can also include machine-learning (ML) algorithms to make decisions about the current “look” of the show based on visual data from the still images (e.g., 2D and 3D) and the video content, as received from, for example, the one or more stage cameras 231. For example, in various embodiments, the haze-control system 200 can use a linear regression and/or other models to find relationships between various inputs and outputs of the elements and components. In a specific exemplary embodiment, if the system senses haze-particle levels that are too low, the system can activate one or more of the haze generators 216. The system can then monitor the increased haze output, e.g., as detected by one or more of the particulate sensors. When the system detects an increase in the haze level, and noting an amount of time elapsed to arrive at the new level of haze (e.g., haze production as a function of time), the system can now adjust internal triggering thresholds to maintain an optimum or desired level of haze more frequently. Such parameters may then be included and maintained within, for example, the database 211.

ML algorithms (e.g., a pre-trained deep-convolutional neural-network based on, for example, a ResNet-18 network) may also be incorporated within the haze-control system 200 to process inputs from the one or more stage cameras 231 to compare a current level of haze to a pre-determined level of haze that is desired for a given scene so that the haze-control system 200 can adjust the level of haze if needed. For example, the disclosed subject matter can use a deep neural-network for processing of visual inputs from the cameras (e.g., in one or both of visible spectrums, infra-red spectrums, and/or ultraviolet spectrums) in order to make qualitative decisions on an overall look of the haze, regardless of other non-visual sensor inputs. The deep neural-network can be trained via photos that an operator specifies as optimal or desirable for a given point in a performance and use that information to base decisions on the atmospheric look. If the ML-determined “look” does not match the expected look form the training photographs, the haze-control system 200 can adjust one or more of the elements and components to achieve the desired look. Further, the AI system can function cooperatively with other systems and components, such as a venue-based HVAC system, to execute intelligent scenic haze-effects.

Moreover, various embodiments of the ML algorithms discussed herein can be used to manage, predictively, a particular scene. The predictive management may be based on parameters such as previously learned sensor and scenic information data sets. These data can allow the ML algorithms to take control to manage various ones of the scenic effects, thereby ensuring a substantial level of scene integrity (e.g., from performance-to-performance and venue-to-venue). For example, the system can determine what level of haze output will yield a given future scenic effect, in both time and spatial domains.

If, for example, a haze-based visual effect, or particulate-sensor count (e.g., spatial concentration) and/or diameter is lower than normal, early in the haze scene-development cycle (e.g., within the first several seconds), and based on information learned from a plurality of previous performances, the ML system could ramp up (or down) the haze early in the scene, to pre-correct for a “pending” near-future scenic-effect or environmental-effect error. Therefore, predictive AI/ML algorithms, based on learned information from previous performances and/or venues, can substantially ensure that future scenes, in the time domain, are managed early in the scenic haze cycle via an AI/ML algorithm to resolve potential haze effect deficiencies. The deficiencies may include differences in haze or other desired environmental effects due to, for example, wind or HVAC-impacts that are affecting reducing the haze or other desired environmental effect. The system as described and disclosed herein recognizes these changes and/or deficiencies, and can predictively and proactively adjust the near-term haze levels to ensure substantially the near-future scenic effects are still realized. Further examples of the use of collected data for AI/ML control scenarios are described herein.

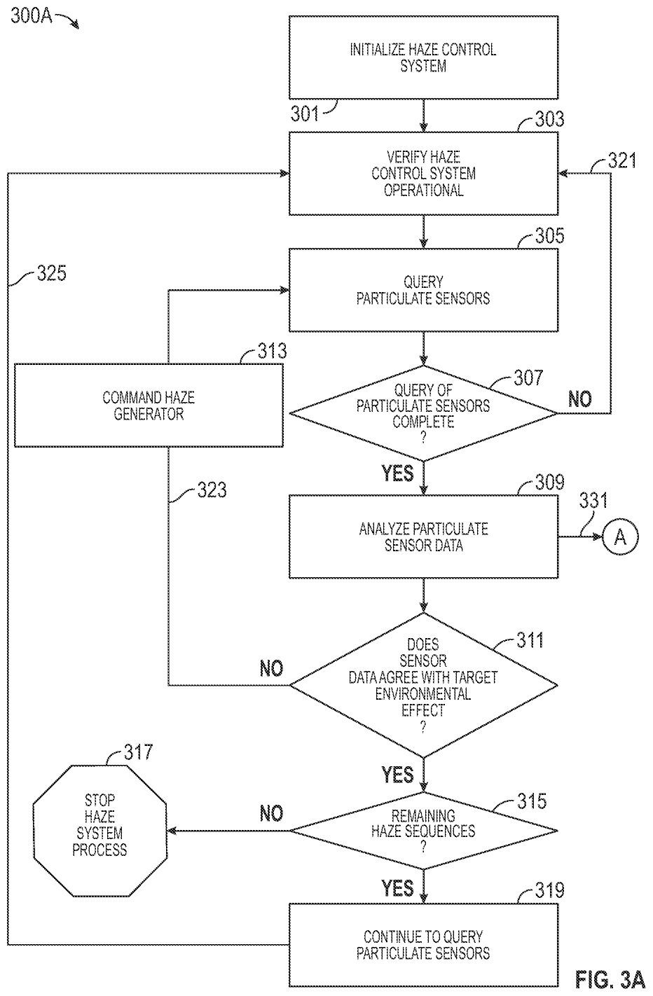

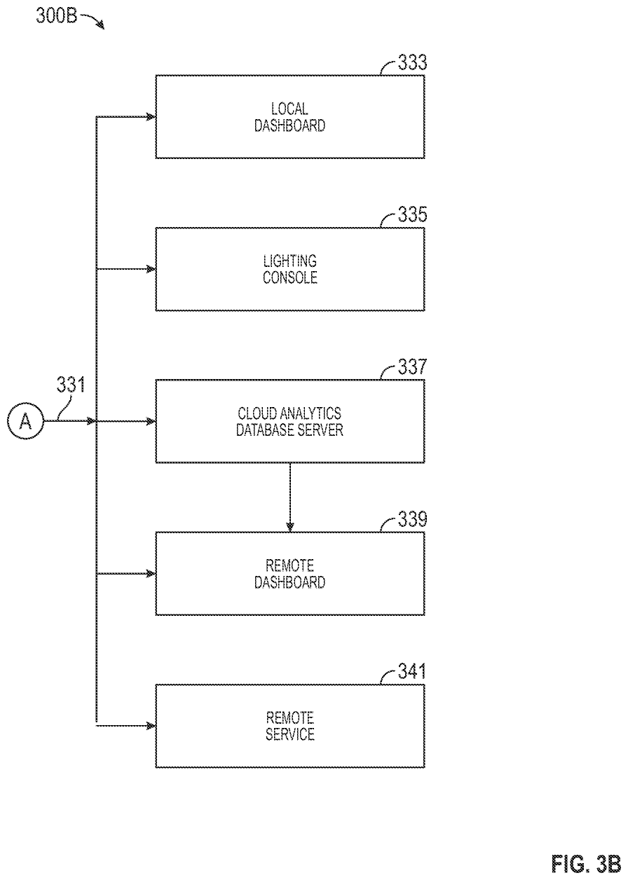

With reference now to FIGS. 3A and 3B, a generalized example of a method for using the haze-control system of, for example, FIG. 1 or FIG. 2, in accordance with various embodiments of the disclosed subject matter described herein is shown. With concurrent reference to either FIG. 1 or FIG. 2, the method 300A of FIG. 3A starts with initializing a haze-control system at operation 301. A verification that the haze-control system is operational may optionally be performed at operation 303.

At operation 305, one or more of the particulate sensors (e.g., the particulate sensors 203₁ to 203_{N} of FIG. 2) are queried for parameters such as particle size and/or particle concentration. The query rate can vary, but can occur, for example, from tens to hundreds to thousands of times per second.

As is understood by a person of ordinary skill in the art, a particle size can affect an ability of the particulate sensors to detect the particles. For example, for a particle that is relatively large with reference to a wavelength of light being used to detect the particle, the particle tends to scatter light more strongly in the forward direction (e.g., near-forward scattering) relative to the backward direction. For particles (or molecules) that are much smaller than the wavelength of the of the detecting light, the particle tends to scatter light more uniformly with reference to forward-scattered and back-scattered light (e.g., such as a dipole radiator). Consequently, the detection of a particle can be dependent on a relative size of the particle. Therefore, in general, particles produced by a haze generator can be determined (e.g., measured) for a pre-determined particle-size range. As a result of the particle-size dependent characteristics regarding particle detection, if a particle size changes significantly, an overall effect of the atmospherics can change significantly as well. However, the haze-control systems disclosed herein are configured to consider and compensate for differences in particle-size generation. For example, the control systems can control parameters within the haze generators (e.g., volumetric flow rates, orifice vibrational rates within the generators, etc.) or determine, algorithmically, light scattering variations produced by produced particle-size ranges.

Moreover, particle shapes and index-of-refraction differences between generated particles can affect the detection efficiency. For example, a haze generator at one venue may use a different type of working fluid to produce particles. The haze generator and type of fluid used may also affect a shape of the particle. However, the haze-control systems disclosed herein can also be configured to account for particle shape and index-of-refraction differences between generated haze particles. For example, the output of a haze generator can be characterized both in terms of a particle-size distribution and aerodynamic-particle sizing, as well as an index-of-refraction of the generated particles (e.g., determined from the index of the generating fluid). Such concepts are understood by a person of ordinary skill in the art. Further, upon reading and understanding the disclosed subject matter, the person of ordinary skill in the art will recognize how to compensate for the various particle factors described herein, either algorithmically or in controlling one or more parameters of the haze generators.

Additionally, depending on the size of a generated particle with reference to a detection wavelength within a particulate sensor, an angle-of-incidence between a light source (e.g., stage lights) and the viewer (e.g., an audience member), a given polarization state of the light source, and so on can alter the perception of the haze. For example, if the angle-of-incidence is 0°, a majority of the incident light may be reflected back toward an audience member; whereas as the angle-of-incidence increases, the direct amount of reflected light reflected diminishes with regard to the audience member. Consequently, the disclosed subject matter can use various types of photometric sensors, distributed in vertical and horizontal planes, to measure a luminous flux per unit area, in correspondence with various lighting positions. This additional set of measurements allows optimization of various the light sources which can be considered in, for example, a touring environment where lighting positions can vary.

Consequently, through the use of various photometric arrays and various visual camera data collected (e.g., by an ML comparison of the data with expected results), the disclosed subject matter can be configured to interpolate the perception of the reflectivity of the haze for various viewing positions, thereby allowing adjustments to the lighting system and atmospheric system in order to improve or optimize the experience from multiple different angles of viewing. Additionally, the various embodiments of the haze-control system can use one or more transmissive sensors to measure the absorption of light in the atmospheric environment. Moreover, the haze-control system can use reflective photometric-sensors to measure how much light is being reflected by the atmospheric environment back into the venue.

Further, the disclosed subject matter can compensate for control of factors such as haze-particle dissipation and dispersion rates, both of which may be dependent on local HVAC systems. For example, using a three-dimensional model of the space, the disclosed subject matter can incorporate and use a drift-flux model to calculate particle dispersion.

Dissipation of the haze is mainly caused by the HVAC system in indoor venues (outdoor venues are also considered, below). Therefore, the disclosed subject matter can calculate the dissipation by estimated amount or volume of haze introduced in to the venue, a measured or calculated subsequent monitoring and dispersion, and an operation of the HVAC system. Based on at least these parameters, the haze-control system can control the HVAC systems to maintain a consistent dissipation rate.

A related concept to dissipation and dispersion can involve Brownian motion of very small particles. Brownian motion is the relative motion of particles due to interactions with gas (e.g., air) molecules and a momentum of those molecules (e.g., a volumetric flowrate of the air produced by the HAVC system). The disclosed subject matter can measure a particle-size range and calculate movement of the size range against the potential effects of Brownian motion. Once the calculations are made, a determination can be made as to whether the effects of Brownian motion need to be considered in terms of dissipation and dispersion of the particles. If Brownian motion is determined to be a factor, the haze-control systems disclosed herein can account for this dispersion as well. For example, the haze-control system can adjust parameters affecting particle-size range within the haze generators or control aspects of the HVAC systems to either limit and/or account for the dissipation and dispersion of the generated particles.

Further, although not shown explicitly herein, other sensors and arrays can be used to control the distribution and locations of haze particles. For example, an ultrasonic array and be directed toward the stage, from various locations, to “push” and shape one or more haze clouds into visually compelling motion effects.

With reference again to the method 300A of FIG. 3A, a determination is made at operation 307 as to whether the query of the particulate sensors is complete (at least for a given time period).

If the system is still completing its programmed or manual sequence of gathering particulate size and count data from the particulate sensors, the querying algorithm will loop back, via path 321, to operation 303 to continue the querying of the particulate sensors. Alternatively, the loop at path 321 can be brought back to operation 305 (not shown in FIG. 3A explicitly).

If the determination is made at operation 307 that the query of the particulate sensors is complete, the method 300A continues to operation 309 to analyze the data received from the particulate sensors. The data can be analyzed by various components (e.g., microprocessors or microcomputers described herein). Analyzed data can then be shared, at path 331, with various components of the haze-control system as described below with reference to FIG. 3B, below.

A determination is made at operation 311 whether the received sensor data agree with the pre-determined target environmental effects. The pre-determined target environmental effect can include, for example, the determination as to whether the generated haze is at, for example, a proper concentration level to achieve the expected visual “look” for a given scene in a performance, as defined above. If the determination is made that the received sensor data do not agree with the pre-determined target environmental effect, the method 300A continues by path 323 to operation 313. At operation 313, the haze generator (e.g., the one or more haze generators 215 of FIG. 2) receives a signal to produce an increased or a decreased amount of haze as needed to match the pre-determined target environmental effect. Additionally, although not shown explicitly, a spatial and/or temporal distribution of haze can be shaped by, for example, an ultrasonic array, as described above. Therefore, at operation 313, for example, the ultrasonic array can also be controlled to “move” the haze clouds or clouds as needed (e.g., into a new and continuing dynamic shape). Further at, for example, operation 311, if the received sensor data do not agree with the pre-determined target environmental effects, an HVAC system (e.g., one or more HVAC systems and/or related mechanisms, such as flow dampers) within the venue (e.g., the HVAC system 235 of FIG. 2) may also receive a signal to control or redirect airflow or raise or lower conditioning of the air (e.g., heating or cooling) within the venue to control environmental effects further.

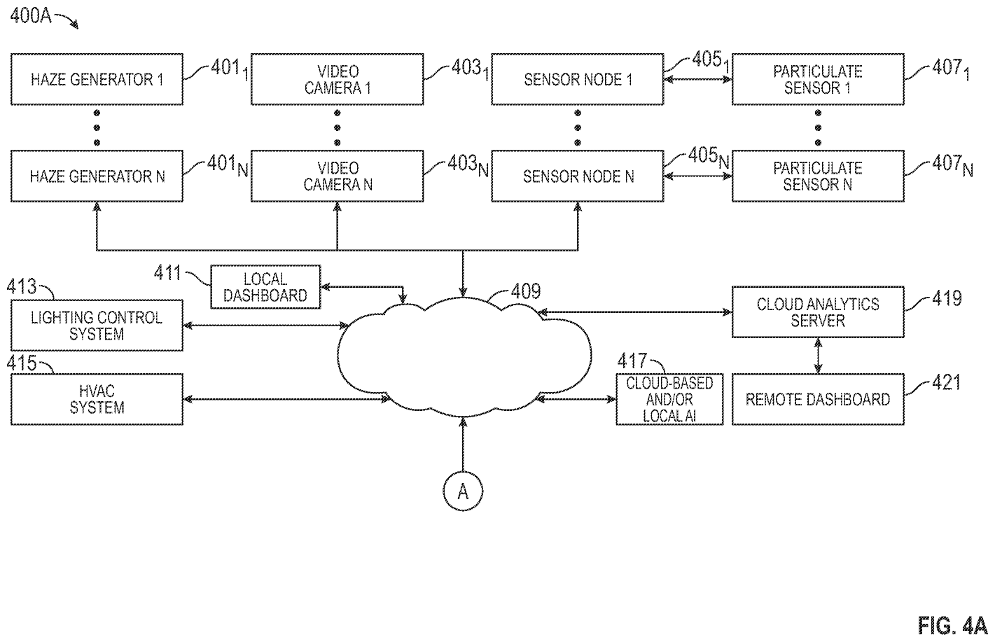

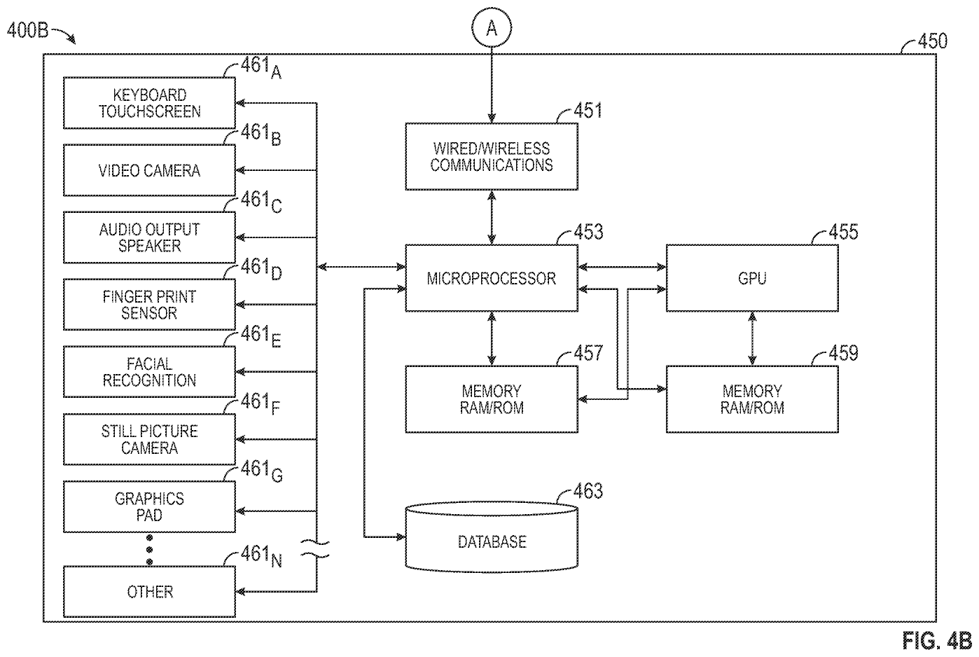

In a specific exemplary embodiment, the control of the haze generators may be implemented in a signal controlled by, for example, various types of algorithms embedded in, for example, software, firmware, and/or hardware components as described herein (e.g., such as the server 113, 213 of FIGS. 1 and 2 and/or one or both of the memory storage units 457, 459 of FIG. 4B). One algorithm may make use of a proportional, integral, derivative (PID) predictive method that examines a current haze envelope as a function of time, and predicts what subsequent levels of haze may be needed to create a future version of a target-haze envelope. A person of ordinary skill in the art, upon reading and understanding the disclosed subject matter, will recognize how to implement a PID, or other type, of control algorithm.

Adjusting the haze generator can comprise changing a size (e.g., producing larger particulates) of the generated particulates and/or increasing the number of haze particulates generated (e.g., an increase in the generates particles per unit volume). If the received particulate data show that the haze level is too high, the haze generator control can comprise changing a size (e.g., producing smaller particulates) of the generated particulates and/or decreasing the number of haze particulates generated. Alternatively, some combination of adjustments to the haze generator can occur as the AI algorithm, described above, determines changes needed to quickly and rapidly converge on a desired pre-determined environmental haze profile, whether that profile is programmed or set manually. The method 300A then continues at operation 305 by continuing to query the particulate sensors.

If the determination is made that the received sensor data do agree with the pre-determined target environmental effect, the method 300A continues to operation 315 to make a determination whether there are remaining haze sequences to be monitored during the performance. A listing of any remaining haze sequences may be stored as, for example, a lookup table (LUT) in the database 211 of FIG. 2 or in another storage location. If there are no further sequences to be monitored, the method 300A ends at operation 317.

If there are further sequences to be monitored, the method 300A continues to operation 319 to continue to query the particulate sensors. The method 300A may then loop back via path 325 to operation 303. Alternatively, the loop at path 325 can be brought back to operation 305 (not shown in FIG. 3A explicitly).

With reference now to FIG. 3B, the method of FIG. 3A continues with an additional portion 300B showing an exemplary embodiment of the continuation of path 331 whereby additional data are shared with various other components in the haze-control system. In this embodiment, at operation 333, the analyzed data are shared a local dashboard (e.g., the one or more local dashboards 219 of FIG. 2). The analyzed data are also shared at operation 335 with a lighting console (e.g., the lighting-control module 221), a cloud-analytics database server (e.g., the cloud-based analytics server 223) at operation 337, a remote dashboard (e.g., the one or more remote dashboards 229) at operation 339, and a remote server (e.g., the remote-service module 125 of FIG. 1, which may also be replicated in the haze-control system 200 of FIG. 2) at operation 341. Also, as indicated, at operation 337, the cloud-analytics database server may also provide additional processing and analytical calculations to send to the remote dashboard at operation 339.

With reference again to operation 337, in various embodiments, during one or more of the haze-control operations disclosed herein, the system could, for example, send a message to the lighting-control system to alter haze levels by sending one or more signals to the one or more haze generators (e.g., the haze generators 115 of FIG. 1). In one exemplary embodiment, the haze levels may be controlled manually by the lighting-control technician or other operator. In other exemplary embodiments, the haze levels may be controlled by the use the data collected in a machine-learning (ML) scenario as described herein. The ML data can allow the system to make anticipatory and predictive changes in various parameters to control environmental effects based on a current performance in combination with collected data from previous performances. The ML data can be used to make qualitative decisions about the future state of the haze based on current parameters and previous performances.

FIGS. 4A and 4B show a specific exemplary embodiment of a block diagram of an example of a haze-control system, in accordance with various embodiments described herein. Each of the components and elements shown in FIGS. 4A and 4B may be the same as or similar to related elements and components of FIGS. 1 and 2. Also, the diagram of FIGS. 4A and 4B may be considered to be a portion of the components and elements of the respective haze-control systems 100, 200, or the diagram of FIGS. 4A and 4B may be considered to be an auxiliary or backup version haze-control system to the haze-control systems 100, 200.

Referring now to FIG. 4A, the first block diagram 400A is shown to include a plurality of haze generators 401₁ to 401_{N}, a plurality of video cameras 403₁ to 403_{N}, a plurality of sensor nodes 405₁ to 405_{N}. Each of the plurality of the haze generators 401₁ to 401_{N}, the video cameras 403₁ to 403_{N}, and the sensor nodes 405₁ to 405_{N} are coupled (e.g., in electronic communication with) to each other and to other components in the diagram via a communication network 409 (e.g., a local-area network (LAN) or a wide-area network (WAN) such as an Intranet and/or the Internet). The LAN/WAN functionality may be wired or wireless, or various combinations thereof. The plurality of sensor nodes 405₁ to 405_{N} are also electronically coupled to a plurality of particulate sensors 407₁ to 407_{N}.

Although the diagram shows a one-to-one correspondence of sensor nodes to particulate sensors, no such correspondence is necessarily intended. For example, a group (e.g., two or more) of particulate sensors may be coupled to a single sensor node. Further, each of the plurality of components is indicated as 1 . . . N. However, there may a larger number of particulate sensor than there are haze generators. Therefore, the quantity “N” is not necessarily consistent from one group of elements or components to another group. All communications within FIGS. 4A and 4B may occur via wireless couplings and/or via wired couplings.

The first block diagram 400A is also shown to include a local dashboard 411, a lighting-control system 413, an HVAC system 415, A cloud-based analytics server 419, and a cloud-based AI module 417 (which may be cloud-based and/or a local module). The cloud-based analytics server 419 may be coupled, for example, via the communication network 409 or via a separate network (not shown), to a remote dashboard. In various embodiments, the cloud-based analytics server 419 may be responsible for running partial or all aspects of the haze-control systems defined herein. In other embodiments, a separate local server (not shown explicitly in FIG. 4A) may either replicate all or a portion of the responsibilities for executing the haze-control systems with, or separate from, the cloud-based analytics server 419. Also, although not shown explicitly, each of the haze-control systems disclosed herein may include a battery-supplied or other type or types of backup-power source to continue system operations in the event of a power failure. Such a backup-power source can be configured to produce a seamlessly switched failover when facilities power (AC power) goes out and comes back on.

In FIG. 4B, the second block diagram 400B (a continuation of the first block diagram 400A) is shown to include a machine 450 (e.g., a personal computer, a micro-processor based tablet, a smartphone, etc.), which includes, for example, a wired, wireless, and/or optically-based communication module 451 electronically coupled to a microprocessor 453. The microprocessor 453 is further electronically coupled to a graphics processing unit (GPU) 455, one or more memory storage units 457, 459, and a local database 463. As shown, the GPU 455 is also coupled electronically to the one or more memory storage units 457, 459.

Various purposes of the local database 463 can include medium- and longer-term storage of acquired data from the plurality of particulate sensors 407₁ to 407_{N}. Additionally, the local database 463 can store post processed data such as multidimensional plots of atmospheric-haze effects, and AI or ML produced projections of what the haze effect will look like for the given venue's stage shape and size, and can also include effects of the venue's HVAC system. Other information can be stored in the database, which may change over time, and as used for operation of the haze-control system. In various embodiments, the GPU 455 may perform all or a portion of AI and ML calculations and simulations.

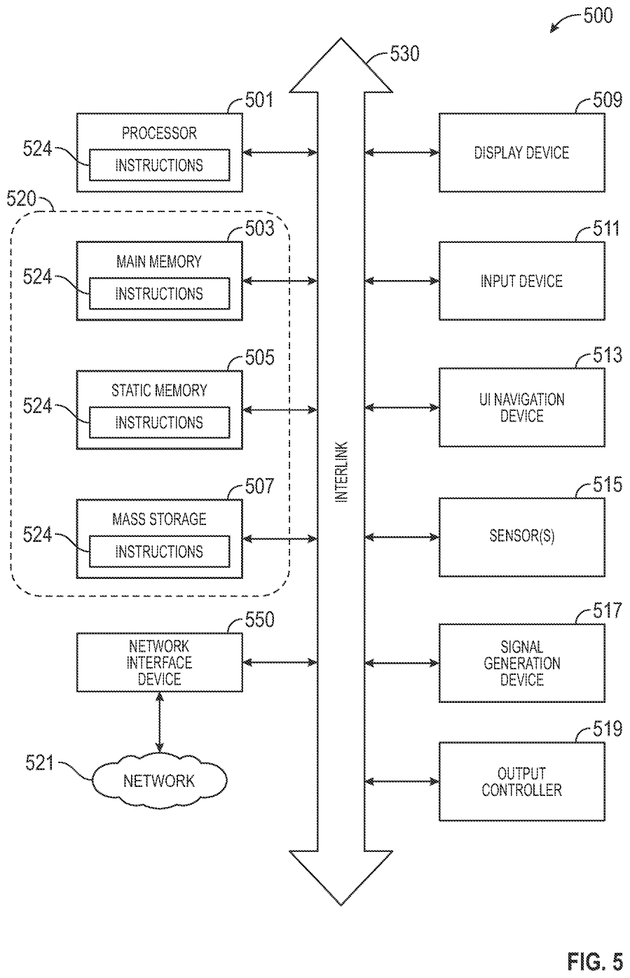

The microprocessor is also shown to be coupled electronically to a plurality of input/output (I/O) devices 461₁ to 461_{N}. The I/O devices include, for example, a keyboard touchscreen 461_{A}, a video camera 461_{B}, an audio speaker 461_{C} (which may also include a microphone), a finger-print sensor 461_{D}, a facial recognition sensor 461_{E}, a, a still-picture camera 461_{F}, a graphics pad 461_{G}, as well as other types of I/O devices 461_{N} (such as wind anemometers, temperature sensors, humidity sensor, etc., for outdoor performances), with some other possible device types described in more detail with reference to FIG. 5, below. Although each of the various elements and components is shown as being within the machine 450, such a configuration is not necessary. For example, various elements and components shown within the machine 450 may be located remotely from the machine 450, such as the input/output devices 461_{A} to 461_{N}.

In a specific exemplary embodiment, the graphics pad 461_{G} may be used to input, for example, hand-drawn haze “clouds” for 2D and 3D scenic effects. The system may then use this “scene sketch” to calculate system parameters used to realize the sketched effect. In various embodiments, 2D and 3D models of productions are often created to speed the development of a new show. End users of the haze-control system, such as designers and directors, can use these models to see how a set will look under lighting with given levels of haze and actor placements. The lighting designer, for example, may then use the 2D and/or 3D models to create lighting cues in advance of a performance. The disclosed subject matter can use these pre-visualizations to train its AI and/or ML models before a show is even in the venue in order to achieve a desired look much faster.

The methods and techniques shown and described herein can be performed using a portion or an entirety of a machine 500 as discussed below in relation to FIG. 5. FIG. 5 shows an exemplary block diagram comprising a machine 500 upon which any one or more of the techniques (e.g., methodologies) discussed herein may be performed. In various examples, the machine 500 may operate as a standalone device or may be connected (e.g., networked) to other machines.

In a networked deployment, the machine 500 may operate in the capacity of a server machine, a client machine, or both in server-client network environments. In an example, the machine 500 may act as a peer machine in peer-to-peer (P2P) (or other distributed) network environment. The machine 500 may be a personal computer (PC), a tablet device, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuitry is a collection of circuits implemented in tangible entities that include hardware (e.g., simple circuits, gates, logic, etc.). Circuitry membership may be flexible over time and underlying hardware variability. Circuitries include members that may, alone or in combination, perform specified operations when operating. In an example, hardware of the circuitry may be immutably designed to carry out a specific operation (e.g., hardwired). In an example, the hardware comprising the circuitry may include variably connected physical components (e.g., execution units, transistors, simple circuits, etc.) including a computer-readable medium physically modified (e.g., magnetically, electrically, such as via a change in physical state or transformation of another physical characteristic, etc.) to encode instructions of the specific operation. In connecting the physical components, the underlying electrical properties of a hardware constituent may be changed, for example, from an insulating characteristic to a conductive characteristic or vice versa. The instructions enable embedded hardware (e.g., the execution units or a loading mechanism) to create members of the circuitry in hardware via the variable connections to carry out portions of the specific operation when in operation. Accordingly, the computer-readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time.

The machine 500 (e.g., computer system) may include a hardware-based processor 501 (e.g., a central processing unit (CPU), a graphics processing unit (GPU), a hardware processor core, or any combination thereof), a main memory 503 and a static memory 505, some or all of which may communicate with each other via an interlink 530 (e.g., a bus, which may be wired, wireless, or based on various other communications types or combinations thereof). The machine 500 may further include a display device 509, an input device 511 (e.g., an alphanumeric keyboard), and a user interface (UI) navigation device 513 (e.g., a mouse). In an example, the display device 509, the input device 511, and the UI navigation device 513 may comprise at least portions of a touch screen display. The machine 500 may additionally include a storage device 520 (e.g., a drive unit), a signal generation device 517 (e.g., a speaker), a network interface device 550, and one or more sensors 515, such as a global positioning system (GPS) sensor, compass, accelerometer, or other sensor. The machine 500 may include an output controller 519, such as a serial controller or interface (e.g., a universal serial bus (USB)), a parallel controller or interface, or other wired or wireless (e.g., infrared (IR) controllers or interfaces, near field communication (NFC), etc., coupled to communicate or control one or more peripheral devices (e.g., a printer, a card reader, etc.).

The storage device 520 may include a machine readable medium on which is stored one or more sets of data structures or instructions 524 (e.g., software or firmware) embodying or utilized by any one or more of the techniques or functions described herein. The instructions 524 may also reside, completely or at least partially, within a main memory 503, within a static memory 505, within a mass storage device 507, or within the hardware-based processor 501 during execution thereof by the machine 500. In an example, one or any combination of the hardware-based processor 501, the main memory 503, the static memory 505, or the storage device 520 may constitute machine readable media.

While the machine readable medium is considered as a single medium, the term “machine readable medium” may include a single medium or multiple media (e.g., a centralized or distributed database, and/or associated caches and servers) configured to store the one or more instructions 524.

The term “machine readable medium” may include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine-readable medium examples may include solid-state memories, and optical and magnetic media. Accordingly, machine-readable media are not transitory propagating signals. Specific examples of massed machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic or other phase-change or state-change memory circuits; magnetic disks, such as internal hard disks and removable disks; magneto-optical disks; and CD-ROM and DVD-ROM disks.

The instructions 524 may further be transmitted or received over a communications network 521 using a transmission medium via the network interface device 550 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., the Institute of Electrical and Electronics Engineers (IEEE) 802.22 family of standards known as Wi-Fi®, the IEEE 802.26 family of standards known as WiMax®), the IEEE 802.25.4 family of standards, peer-to-peer (P2P) networks, among others. In an example, the network interface device 550 may include one or more physical jacks (e.g., Ethernet, coaxial, or phone jacks) or one or more antennas to connect to the communications network 526. In an example, the network interface device 550 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 500, and includes digital or analog communications signals or other intangible medium to facilitate communication of such software.

As used herein, the term “or” may be construed in an inclusive or exclusive sense. Further, other embodiments will be understood by a person of ordinary skill in the art based upon reading and understanding the disclosure provided. Moreover, the person of ordinary skill in the art will readily understand that various combinations of the techniques and examples provided herein may all be applied in various combinations.

Throughout this specification, plural instances may implement components, operations, or structures described as a single instance. Although individual operations are illustrated and described as separate operations, one or more of the individual operations may be performed concurrently, and, unless otherwise stated, nothing requires that the operations necessarily be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter described herein.

Further, although not shown explicitly but understandable to a skilled artisan, each of the various arrangements, quantities, and number of elements may be varied (e.g., the number of haze-control systems, particulate sensors, backup power systems, etc.). Moreover, each of the examples shown and described herein is merely representative of one possible configuration and should not be taken as limiting the scope of the disclosure.

Although various embodiments are discussed separately, these separate embodiments are not intended to be considered as independent techniques or designs. As indicated above, each of the various portions may be inter-related and each may be used separately or in combination with other embodiments discussed herein. For example, although various embodiments of operations, systems, and processes have been described, these methods, operations, systems, and processes may be used either separately or in various combinations.

Consequently, many modifications and variations can be made, as will be apparent to a person of ordinary skill in the art upon reading and understanding the disclosure provided herein. Functionally equivalent methods and devices within the scope of the disclosure, in addition to those enumerated herein, will be apparent to the skilled artisan from the foregoing descriptions. Portions and features of some embodiments may be included in, or substituted for, those of others. Such modifications and variations are intended to fall within a scope of the appended claims. Therefore, the present disclosure is to be limited only by the terms of the appended claims, along with the full scope of equivalents to which such claims are entitled. It is also to be understood that the terminology used herein is for the purpose of describing particular embodiments only and is not intended to be limiting.

Further, although the disclosed subject matter is defined in terms of various entertainment venues and performance types, no such limitation is intended. The disclosed subject matter is disclosed of these performance types merely to convey one aspect of how the claimed invention may be utilized. For example, upon reading and understanding the disclosed subject matter, a person of ordinary skill in the art will recognize that the disclosed subject matter can readily be adapted in other environments as well. Such environments include, but are not limited to, ventilation of automobile tunnels, ventilation in mining operations, ventilation of various types of factories, and ventilation of smoke from buildings and other locations.

The Abstract of the Disclosure is provided to allow the reader to ascertain quickly the nature of the technical disclosure. The abstract is submitted with the understanding that it will not be used to interpret or limit the claims. In addition, in the foregoing Detailed Description, it may be seen that various features may be grouped together in a single embodiment for the purpose of streamlining the disclosure. This method of disclosure is not to be interpreted as limiting the claims. Thus, the following claims are hereby incorporated into the Detailed Description, with each claim standing on its own as a separate embodiment.

The description provided herein includes illustrative examples, devices, and apparatuses that embody various aspects of the matter described in this document. In the description, for purposes of explanation, numerous specific details are set forth in order to provide an understanding of various embodiments of the matter discussed. It will be evident however, to those of ordinary skill in the art, that various embodiments of the disclosed subject matter may be practiced without these specific details. Further, well-known structures, materials, and techniques have not been shown in detail, so as not to obscure the various illustrated embodiments. As used herein, the terms “about,” “approximately,” and “substantially” may refer to values that are, for example, within ±10% of a given value or range of values.

### THE FOLLOWING NUMBERED EXAMPLES ARE SPECIFIC EMBODIMENTS OF THE DISCLOSED SUBJECT MATTER

Example 1: A method for controlling atmospheric effects in a venue, where the method includes initializing a haze-control system; querying and receiving data from at least one sensor; analyzing particulate sensor-data received from the at least one sensor; and making a determination whether the sensor-data substantially agrees with a pre-determined target level of an environmental effect. Based on a determination that the sensor-data does not agree substantially with the pre-determined target level of the environmental effect, the method also includes sending a command signal to one or more haze generators to vary a haze production level; and based on a determination that the sensor-data does agree substantially with the pre-determined target level of the environmental effect, the method also includes making a determination whether additional haze sequences remain to be completed within the venue.
Example 2: The method of Example 1, wherein a number of the at least one sensor is chosen based on an overall volume within an environment in which the atmospheric effects in the venue are to be controlled.
Example 3: The method of either Example 1 or Example 2, further comprising controlling a level of haze by at least one parameter selected from haze particle-size measurements and a concentration level of the haze.
Example 4: The method of Example 3, wherein the at least one parameter to determine the level of haze is integrated in both time and spatial volume to determine a desired level of haze particulates being generated.
Example 5: The method of Example 3, wherein the level of the haze is integrated as a function of time to determine when exposure levels have reached potentially harmful levels to a performer within the venue.
Example 6: The method of any one of the preceding Examples, further comprising providing a substantially consistent visual effect of the atmospheric effects, the visual effect being substantially independent of the venue in which a live production is performed.
Example 7: The method of any one of the preceding Examples, further comprising spatially integrating readings from the at least one sensor to determine a spatial distribution of the haze.
Example 8: The method of any one of the preceding Examples, further comprising determining a temporal distribution of the haze across a defined spatial extent within the venue.
Example 9: The method of any one of the preceding Examples, further comprising comparing readings from each of the at least one sensor with a pre-determined level of haze that is correlated with a given scene of a performance within the venue.
Example 10: A system to control atmospheric effects within a venue, where the system includes at least one sensor and a server configured to collect data from the at least one sensor. The server is further arranged to analyze the collected data and make a determination whether the sensor-data substantially agrees with a pre-determined target level of an environmental effect. The server is further configured to control one or more haze generators based on the determination that the sensor-data does not substantially agree with the pre-determined target level of the environmental effect. The system also includes at least one dashboard to view at least analyzed versions of the collected data. The at least one dashboard is further arranged to control at least the server. A database is coupled to be accessible by the server. The database includes a lookup table of a plurality of pre-determined target levels of environmental effects for the venue.
Example 11: The system of Example 10, wherein the at least one dashboard is configured to display metrics and data from the system, the display including at least one type of representation selected from numerical, graphical, and visual representations.
Example 12: The system of either Example 10 or Example 11, wherein multiple distributed ones of the at least one sensor are located spatially in the venue to count aerosolized particles from the one or more haze generators in a substantially real-time manner within a selected spatial volume.
Example 13: The system of any one of Example 10 through Example 12, wherein the at least one dashboard is configured to operate as a local intranet.
Example 14: The system of any one of Example 10 through Example 13, wherein the at least one sensor includes at least one sensor type selected from optical particle-counters (OPCs) and condensation particle-counters (CPCs).
Example 15: The system of any one of Example 10 through Example 14, further comprising a central computer processor that is configured to aggregate the collected data and analyzes a composite haze environment for a selected time element.
Example 16: A tangible, computer-readable medium to perform operations, that when executed by one or more hardware-based computers of a machine, cause the machine to performs operations including initializing a haze-control system; querying and receiving data from at least one sensor; analyzing sensor-data received from the at least one sensor; and making a determination whether the sensor-data substantially agrees with a pre-determined target level of an environmental effect. Based on a determination that the sensor-data does not agree substantially with the pre-determined target level of the environmental effect, the method also includes sending a command signal to one or more haze generators to vary a haze production level; and based on a determination that the particulate sensor-data does agree substantially with the pre-determined target level of the environmental effect, the method also includes making a determination whether additional haze sequences remain to be completed within the venue.
Example 17: The tangible, computer-readable medium of Example 16, wherein the operations further comprise controlling a level of haze by at least one parameter selected from haze particle-size measurements and a concentration level of the haze.
Example 18: The tangible, computer-readable medium of Example 17, wherein the at least one parameter to determine the level of haze is integrated in both time and spatial volume to determine a desired level of haze particulates being generated.
Example 19: The tangible, computer-readable medium of Example 17, wherein the level of the haze is integrated as a function of time to determine when exposure levels have reached potentially harmful levels to a performer within the venue.
Example 20: The tangible, computer-readable medium of any one of Example 16 through Example 19, wherein the operations further comprise providing a substantially consistent visual effect of atmospheric effects, the visual effect being substantially independent of the venue in which a live production is performed.

What is claimed is:

1. A method for controlling atmospheric effects in a venue, the method comprising:
initializing a haze-control system;
querying and receiving data from at least one sensor;
analyzing sensor-data received from the at least one sensor;
making a determination whether the sensor-data substantially agrees with a pre-determined target level of an environmental effect; and
based on a determination that the sensor-data does not agree substantially with the pre-determined target level of the environmental effect, sending a command signal to one or more haze generators to vary a haze production level; and
based on a determination that the sensor-data does agree substantially with the pre-determined target level of the environmental effect, making a determination whether additional haze sequences remain to be completed within the venue.

2. The method of claim 1, wherein a number of the at least one sensor is chosen based on an overall volume within an environment in which the atmospheric effects in the venue are to be controlled.

3. The method of claim 1, further comprising controlling a level of haze by at least one parameter selected from haze particle-size measurements and a concentration level of the haze.

4. The method of claim 3, wherein the at least one parameter to determine the level of haze is integrated in both time and spatial volume to determine a desired level of haze particulates being generated.

5. The method of claim 3, wherein the level of the haze is integrated as a function of time to determine when exposure levels have reached potentially harmful levels to a performer within the venue.

6. The method of claim 1, further comprising providing a substantially consistent visual effect of the atmospheric effects, the visual effect being substantially independent of the venue in which a live production is performed.

7. The method of claim 1, further comprising spatially integrating readings from the at least one sensor to determine a spatial distribution of the haze.

8. The method of claim 1, further comprising determining a temporal distribution of the haze across a defined spatial extent within the venue.

9. The method of claim 1, further comprising comparing readings from each of the at least one sensor with a pre-determined level of haze that is correlated with a given scene of a performance within the venue.

10. A system to control atmospheric effects within a venue, the system comprising:
at least one sensor;
a server configured to collect data from the at least one sensor, the server further to analyze the collected data and make a determination whether sensor-data from the collected data substantially agrees with a pre-determined target level of an environmental effect, the server further configured to control one or more haze generators based on the determination the sensor-data does not substantially agree with the pre-determined target level of the environmental effect;
at least one dashboard to view at least analyzed versions of the collected data, the at least one dashboard further to control the server; and
a database coupled to be accessible by the server, the database including a lookup table of a plurality of pre-determined target levels of environmental effects for the venue.

11. The system of claim 10, wherein the at least one dashboard is configured to display metrics and data from the system, the display including at least one type of representation selected from numerical, graphical, and visual representations.

12. The system of claim 10, wherein multiple distributed ones of the at least one sensor are located spatially in the venue to count aerosolized particles from the one or more haze generators in a substantially real-time manner within a selected spatial volume.

13. The system of claim 10, wherein the at least one dashboard is configured to operate as a local intranet.

14. The system of claim 10, wherein the at least one sensor includes at least one sensor type selected from optical particle-counters (OPCs) and condensation particle-counters (CPCs).

15. The system of claim 10, further comprising a central computer processor that is configured to aggregate the collected data and analyzes a composite haze environment for a selected time element.

16. A tangible, computer-readable medium to perform operations, that when executed by one or more hardware-based computers of a machine, cause the machine to performs operations comprising:
initializing a haze-control system within a venue;
querying and receiving data from at least one sensor;
analyzing sensor-data received from the at least one sensor;
making a determination whether the sensor-data substantially agrees with a pre-determined target level of an environmental effect; and
based on a determination that the sensor-data does not agree substantially with the pre-determined target level of the environmental effect, sending a command signal to one or more haze generators to vary a haze production level; and
based on a determination that the particulate sensor-data does agree substantially with the pre-determined target level of the environmental effect, making a determination whether additional haze sequences remain to be completed within the venue.

17. The tangible, computer-readable medium of claim 16, wherein the operations further comprise controlling a level of haze by at least one parameter selected from haze particle-size measurements and a concentration level of the haze.

18. The tangible, computer-readable medium of claim 17, wherein the at least one parameter to determine the level of haze is integrated in both time and spatial volume to determine a desired level of haze particulates being generated.

19. The tangible, computer-readable medium of claim 17, wherein the level of the haze is integrated as a function of time to determine when exposure levels have reached potentially harmful levels to a performer within the venue.

20. The tangible, computer-readable medium of claim 16, wherein the operations further comprise providing a substantially consistent visual effect of atmospheric effects, the visual effect being substantially independent of the venue in which a live production is performed.
